(19) United States
(12) Patent Application Publication
(10) Pub. No.: US 2005/0147715 A1
(43) Pub. Date: Jul. 7, 2005

(54) Dairy product comprising texturizers

(75) Inventors: Khadija Schwach-Abdellaoui, Frederiksberg (DK); Jorgen Thorball, Virum (DK); Rikke Malene Joergensen, Birkeroed (DK)

Correspondence Address: NOVOZYMES NORTH AMERICA, INC., 500 FIFTH AVENUE, SUITE 1600, NEW YORK, NY, 10110, US

(73) Assignees: Novozymes Biopolymer A/S, Bagsvaerd (DK); Christian Hansen A/S, Horsholm (DK)

(21) Appl. No.: 11/016,639

(22) Filed: Dec. 17, 2004

Related U.S. Application Data
(60) Provisional application No. 60/531,191, filed on Dec. 19, 2003.

(30) Foreign Application Priority Data
Dec. 17, 2003 (DK) PA 2003 01869

(51) Int. Cl. A23C 9/12

(52) U.S. Cl. 426/36

(57) ABSTRACT

The present invention relates to a method for improving the textural properties of a dairy product by using a combination of hyaluronic acid and a second texturizing agent for producing the dairy product, and to a dairy product comprising hyaluronic acid and a second texturizing agent.

### CROSS REFERENCE TO RELATED APPLICATIONS

This application claims priority or the benefit under 35 U.S.C. 119 of Danish application no. PA 2003 01869 filed Dec. 17, 2003 and U.S. provisional application No. 60/531,191 filed Dec. 19, 2003, the contents of which are fully incorporated herein by reference.

### BACKGROUND OF THE INVENTION

1. Field of the Invention

The present invention relates to a dairy product comprising hyaluronic acid and a second texturizer, a method of producing the dairy product, and use of hyaluronic acid in combination with a second texturizer for producing a dairy product.

2. Description of Related Art

Glycosaminoglycans such as hyaluronic acid are negatively charged molecules, and have an extended conformation. Glycosaminoglycans are located primarily on the surface of cells or in the extracellular matrix. Glycosaminoglycans also have low compressibility in solution. As such, glycosaminoglycans are ideal as a lubricating fluid, and are found naturally in the joints. The rigidity of glycosaminoglycans provides structural integrity to cells and provides passageways between cells, allowing for cell migration.

Hyaluronic acid is also suspected of having a role in numerous physiological functions, such as adhesion, development, cell motility, cancer, angiogenesis, cartilage enhancement and wound healing.

U.S. Pat. No. 6,432,929 discloses a cartilage enhancing food supplement comprising hyaluronic acid.

In dairy products the texture, mouthfeel and stability may be enhanced by addition of texturising agents. These agents typically bind water and/or increase the viscosity of the product. Texturizing agents may also be used to replace fat in low fat dairy products. Examples of texturizing agents are gelatine and pectin.

It is an object of the present invention to provide a dairy product with enhanced textural properties.

### SUMMARY OF THE INVENTION

The inventors have found that when hyaluronic acid and a second texturizer is added to a dairy product it affects the textural properties of the dairy product to a greater extent than what can be achieved by adding hyaluronic acid or the second texturizing agent alone.

The invention thus relates in a first aspect to a dairy product comprising hyaluronic acid and a second texturizing agent and one or more milk components and/or milk fractions. In further aspects the invention relates to a method for preparing a dairy product and to use of hyaluronic acid and a second texturizing agent for preparing a dairy product.

### DETAILED DESCRIPTION OF THE INVENTION

Hyaluronic Acid

In the context of the present invention the term “hyaluronic acid” covers hyaluronic acid as such as well as a salt of hyaluronic acid, a hyoluronate.

Hyaluronic acid is an unsulphated glycosaminoglycan with a simple structure of repeating disaccharide units of N-acetyl-glucosamine and D-glucuronic acid. The sugars are linked together by alternating beta-1,4 and beta-1,3 glycosidic bonds. Hyaluronic acid has a molecular weight usually in the range from about 100 kDa to about 4000 kDa.

In one embodiment of the invention the amount of hyaluronic acid in the dairy product is in the range 0.001-10% (weight/weight), such as in the range 0.005-5%, preferably in the range 0.01-2%, more preferably in the range 0.01-1%.

Sources of Hyaluronic Acid

A main commercial source of hyaluronic acid is chicken or rooster comb, which has hyaluronic acid at a higher concentration than other animal tissues. Another important source of hyaluronic acid is microorganisms, through a fermentation process. U.S. Pat. No. 4,801,539 (Akasaka et al.) discloses a method for preparing hyaluronic acid. Yields from a strain of S. zooepidemicus are reported of about 3.6 g/l. In European patent EP 0694616, yields of about 3.5 g/l are reported from fermentation processes using an improved strain of S. zooepidemicus.

In a preferred embodiment of the invention hyaluronic acid is in the form of a salt of hyaluronic acid, a hyaluronate, such as e.g. sodium hyaluronate, or calcium hyaluronate.

Hyaluronic acid according to the invention may be from any source known in the art, such as e.g. from rooster or chicken comb or from a microorganism. In a preferred embodiment hyaluronic acid is produced by a microorganism, such as e.g. by a strain of Streptococcus, such as e.g. S. zooepidemicus, a strain of Pasteurella, such as e.g. P. multocida, or a strain of Bacillus.

Second Texturizing Agent

A texturizing agent is a component that when present in small amounts affects the texture of a food product, e.g. a component that increases the viscosity and/or gel stiffness of a food product. Texturizing agents are often high molecular weight components capable of binding water in the product. The second texturizing agent of the invention may be any texturizing agent suitable for addition to a dairy product. The texturizing agent may be a carbohydrate such as e.g. starch, modified starch, pectin, carageenan, locust bean gum, an alginate, agar agar, xanthan gum, guar gum, microcrystalline cellulose, chitin, chitosan, and/or konjac. The texturizing agent may also be a protein such as e.g. gelatine or milk proteins.

The amount of second texturizing agent is chosen so as to achieve the desired effect upon the texture of the product, and may vary depending on the product and the effect to be achieved. If the second texturizing agent is e.g. starch the amount may e.g. be in the range 0.1-20% (weight/weight) of the food product, such as 0.2-10%, 0.5-5%, or 0.5-3%.

The second texturizing agent may be formulated in any way suitable for the use in manufacture of a dairy product, e.g. the second texturizing agent may be mixed with other components. In one embodiment of the invention hyaluronic acid and second texturizing agent are mixed together. The mixture may contain further components.

Dairy Product

A dairy product according to the invention may be any food product produced on the basis of one or more milk components and/or milk fractions. A Milk component may be any component of milk such as e.g. milk fat, milk protein, casein, whey protein, or lactose. A milk fraction may be any fraction of milk such as e.g. skimmed milk, butter milk, whey, cream, butter, milk treated by ultrafiltration, milk powder, whole milk powder, butter milk powder, or skimmed milk powder.

In the present context milk may be the lacteal secretion of any mammal. Thus, milk may be obtained by milking, e.g., cows, sheep, goats, buffaloes, or camels.

A dairy product may additionally comprise non-milk components, e.g. vegetable components such as e.g. vegetable oil, vegetable protein, and/or vegetable carbohydrates. Dairy products may also comprise further additives such as e.g. enzymes, flavouring agents, microbial cultures, salts, sweeteners, sugars, acids, fruit, fruit juices, or any other component known in the art as a component of, or additive to, a dairy product. In a preferred embodiment the dairy product comprises probiotic cultures, i.e. cultures of living microorganisms, which upon ingestion by humans, exert health benefits beyond inherent basic nutrition. Probiotic cultures may e.g. comprise Bifidobacteria and/or Lactobacilli. A dairy product according to the invention may e.g. be skimmed milk, whole milk, cream, a fermented milk product, cheese, yoghurt, butter, dairy spread, butter milk, acidified milk drink, sour cream, whey based milk drink, ice cream, or a flavoured milk drink. A dairy product may be manufactured by any method known in the art.

In one embodiment the invention relates to a method for producing a dairy product comprising (a) mixing hyaluronic acid and second texturizing agent with milk and/or one or more milk components and/or one or more milk fractions; and (b) producing a dairy product from the mixture resulting from step (a).

In one embodiment of the invention one or more milk components and/or milk fractions account for at least 50% (weight/weight), such as at least 70%, e.g. at least 80%, preferably at least 90%, of the dairy product.

Fermented Dairy Product

In a preferred embodiment of the invention the dairy product is a fermented dairy product. In the present context the term “fermented dairy product” is to be understood as any dairy product wherein any type of fermentation forms part of the production process. Examples of fermented dairy products are products like yoghurt, buttermilk, creme fraiche, quarg and fromage frais. A fermented dairy product may be produced by any method known in the art. In a preferred embodiment the dairy product is yoghurt. Fermentation may be performed by inoculation with a starter culture, which is chosen depending on the product to be produced.

Examples of starter cultures to be used according to the invention are lactic starter cultures, such as yoghurt cultures (Lactobacillus delbrueckii subsp. bulgaricus and Streptococcus thermophilus). Starter cultures may e.g. comprise Lactobacillus spp, e.g. Lactobacillus acidophilus and Lactobacillus delbrueckii subsp. lactis, Lactococcus spp, Streptococcus spp., Leuconostoc spp., and Bifidobacteria. Such cultures are readily available from e.g. Chr. Hansen A/S, Hørsholm, Denmark. However, any starter culture known in the art and suitable for producing a fermented dairy product may be used.

Doses of starter culture added and incubation temperatures vary depending e.g. on the culture and/or dairy composition used and the final product required. However, a culture dose is often in the range equivalent to 0.005-0.05% frozen concentrate. The fermentation is often carried out at temperatures between 20 and 50° C. for about 30 minutes to 16 hours. In one embodiment stirring and/or homogenization is carried out after fermentation. In another embodiment heat treatment is carried out after fermentation.

As a result of fermentation or acidification pH may be lowered. The pH of a fermented dairy product of the invention may e.g. be in the range 3.5-6.5, such as in the range 3.5-6, preferably in the range 3.5-5.

Cheese

In a preferred embodiment the dairy product is cheese. In the present context, the term “cheese” refers to any kind of cheese such as e.g. natural cheese, cheese analogues and processed cheese. The cheese may be obtained by any suitable process known in the art, such as e.g. by enzymatic coagulation of a milk based composition with rennet, or by acidic coagulation with food grade acid or acid produced by lactic acid bacteria growth. In one embodiment, the cheese manufactured by the process of the invention is rennet-curd cheese. Rennet is commercially available, e.g. as Naturen® (animal rennet), Chy-ma® (fermentation produced chymosin), Microlant® (Microbial coagulant produced by fermentation), all from Chr. Hansen A/S, Hørsholm, Denmark. The cheese may be produced by a conventional cheese-making process.

The cheese produced by the process of the present invention comprises all varieties of cheese, e.g. hard cheeses such as Chester, Danbo, Manchego, Saint Paulin, Cheddar, Monterey, Colby, Edam, Gouda, Muenster, Swiss type, Gruyere, Emmenthaler, Parmesan and Romano; pasta filata cheeses such as Mozzarella; processed cheese; white mould cheese such as Brie and Camembert; or blue mould cheeses such as Gorgonzola and Danish blue cheese. In a preferred embodiment the dairy product is fresh cheese such as e.g. Ricotta, Cream cheese, Neufchatel or Cottage cheese.

Processed cheese is preferably manufactured from cheese or cheese analogues by cooking and emulsifying the cheese, such as with emulsifying salts (e.g. phosphates and citrate). The process may further include the addition of spices/condiments.

The term “cheese analogues” refers to cheese-like products which contain fat, such as e.g. milk fat (e.g. cream or butter) or vegetable oil, as a part of the composition, and which further contain, as part of the composition, one or more non-milk constituents, such as e.g. a vegetable constituent (e.g. vegetable protein or vegetable oil).

Ice Cream

In one embodiment of the invention the dairy product is ice cream. In the present context ice cream may be any kind of ice cream such as full fat ice cream, low fat ice cream, sorbet, or ice cream based on yoghurt or other fermented milk product. Ice cream may be manufactured by any method known in the art, and hyaluronic acid and the second texturizing agent may be added at any appropriate step in the process. In one embodiment hyaluronic acid and the second texturizing agent is blended into the ice cream mix. If the ice cream mix is homogenized hyaluronic acid and second texturizing agent may be added before or after homogenization.

Addition of Hyaluronic Acid and Second Texturizing Agent

Hyaluronic acid and second texturizing agent may e.g. be added to the raw materials used for producing the dairy product of the invention, they may be added at any appropriate step during the manufacturing process, or they may be added to the finished dairy product. Hyaluronic acid and second texturizing agent may be added simultaneously, e.g. hyaluronic acid and second texturizing agent may be mixed together before addition, or they may be added separately, e.g. at different steps of the manufacturing process. Hyaluronic acid and second texturizing agent may be added in the same way and at the same step of the manufacturing process as texturizing agents are normally added when producing the respective dairy product.

If the dairy product of the invention is cheese, hyaluronic acid and second texturizing agent may e.g. be added before, simultaneously with, or after addition of rennet. If the dairy product is process cheese hyaluronic acid and second texturizing agent may e.g. be added before, during, or after cooking.

Hyaluronic acid and second texturizing agent may be added at any appropriate temperature, e.g. in the range 0-100° C. In one embodiment of the invention hyaluronic acid and texturizing agent is added at a temperature in the range 0-40° C., such as 0-30° C., 2-20° C., or 2-15° C. In another embodiment of the invention hyaluronic acid and texturizing agent is added at a temperature in the range 40-100° C., such as 50-90° C., 60-90° C., or 60-80° C.

In one embodiment of the invention hyaluronic acid and second texturizing agent is used in amounts sufficient to increase the viscosity, gel stiffness, and/or mouthfeel of the dairy product compared to the dairy product without hyaluronic acid and second texturizing agent. In a further embodiment of the invention hyaluronic acid and second texturizing agent is used in amounts sufficient to increase the viscosity, gel stiffness, and/or mouthfeel of the dairy product compared to the dairy product with hyaluronic acid or second texturizing agent alone.

### EXAMPLES

Materials
Hyaluronic acid: Sodium hyaluronate, topical grade, produced by fermentation of Streptococcus (Shandong Freda, China).
Second texturizers:
Dynatex 3201 B (Creative Food Systems, Marlow, Buckinghamshire, UK), 50% Modified starch and 50% Casein.
Wheat starch, Sigma S-5127 (Sigma-Aldrich, St. Louis, USA).
Corn starch, Cerestar (Cargill Cerestar BVBA, Mechelen, Belgium).
Waxy maize starch, Cerestar 04201 (Cargill Cerestar BVBA, Mechelen, Belgium).
Yoghurt culture: FD-DVS YF-3331 (Chr. Hansen A/S, Hørsholm, Denmark)

Methods

Each yoghurt sample was made in a volume of 200 ml of milk which had been supplemented by the specified amounts of dry matter (hyaluronic acid and second texturizing agent). Handling of the sample took place according to the procedure described below. The individual steps of the procedure are given in sequential order.

Addition of Dry Matter

The dry matter was either added to hot milk or cold milk using one of the two procedures described below.

Addition of Dry Matter to Cold Milk

A magnet was placed in the bottle of cold milk supplemented with dry matter. The bottle with the magnet was placed on a stirrer and kept in the refrigerator (8° C.) until the following day, where the heat treatment and incubation took place.

Addition of Dry Matter to Hot Milk

The dry matter was added to 70° C. hot milk (1.5% fat, 3.4% protein, 8.1% milk solids non fat). Thorough mixing for five minutes with a turbine blender (Ystral X10/20-750, Germany) ensured complete dissolution of the powder in the milk. This step was carried out the day prior to the incubation. The bottle of milk was then placed overnight in the refrigerator set at 8° C.

Pasteurization

The samples were then either batch pasteurized or flow pasteurized.

Batch pasteurization consisted in heating the bottles by means of a water bath and keeping them at 85° C. for 30 minutes.

Flow pasteurization consisted in pumping the milk through a metal coil placed in a water bath kept at 92° C. The retention time of the milk in the heated section of the coil was 5 minutes.

Incubation

The bottles were then cooled to the temperature of incubation (43° C.). For all products, the inoculation rate was 50 U/250 L. When pH reached 4.55, the products were taken out of the water bath.

Post-Incubation Treatment

Upon incubation the products were either manually blended or mixed with the same turbine mixer as above. Manual blending required use of a small stick, equipped at its end with a holed disk of a diameter of 5 cm. Upon blending, the product was cooled to 25° C. in a water bath and finally placed in the refrigerator, set at 8° C.

Rheology profiles were established for all products the day after the incubation.

Rheology Measurements

The yoghurt samples were subjected to oscillation and viscometry measurements. The yoghurts were brought to a temperature of 13° C. Measurements were conducted with a StressTech rheometer (Reologica Instruments, Sweden). A coaxial measuring system C25 was used.

The oscillation test was a controlled stress (0.6 Pa) frequency sweep measuring the complex modulus (G*) at 6 frequencies from 0.5 to 8 Hz after a 300 s thermal equilibrium time. Delay time was defined as 5 s and integration time as 10 s. For further analysis G* at 1 Hz was chosen.

The viscometry test was made with shear rates varying from 0.27 to 300 1/s in 21 steps. Shear rates were increased and then decreased and the up and down curves of shear stress and apparent viscosity were recorded. Delay and integration times were 5 s and 10 s, respectively. For further analysis shear stress at 300 1/s was selected.

### Example 1

0.01% and 0.02% hyaluronic acid added to cold and hot milk, results are shown in Table 1.

TABLE 1

| | Cold milk | | Hot milk | |
|---|---|---|---|---|
| Hyaluronic | Gel | Shear | Gel | Shear |
| acid (%) | stiffness (Pa) | stress (Pa) | stiffness (Pa) | stress (Pa) |
| 0 | 133 | 25.1 | 148 | 28.0 |
| 0.01 | 182 | 27.7 | 153 | 28.1 |
| 0.02 | 225 | 28.5 | 192 | 28.1 |

### Example 2

0.01% and 0.02% hyaluronic acid added to cold and hot milk with 1% Dynatex 3201B texturizer, results are shown in Table 2.

TABLE 2

| | Cold milk | | Hot milk | |
|---|---|---|---|---|
| Hyaluronic | Gel | Shear | Gel | Shear |
| acid (%) | stiffness (Pa) | stress (Pa) | stiffness (Pa) | stress (Pa) |
| 0 | 272 | 43.8 | 229 | 41.1 |
| 0.01 | — | 45.0 | — | 53.0 |
| 0.02 | 317 | 54.4 | 323 | 51.4 |

### Example 3

0.01% and 0.02% hyaluronic acid added to cold and hot milk with 1% wheat starch, results are shown in Table 3.

TABLE 3

| | Cold milk | | Hot milk | |
|---|---|---|---|---|
| Hyaluronic | Gel | Shear | Gel | Shear |
| acid (%) | stiffness (Pa) | stress (Pa) | stiffness (Pa) | stress (Pa) |
| 0 | 118 | 28.7 | 152 | 35.1 |
| 0.01 | 124 | 40.3 | 177 | 48.7 |
| 0.02 | 154 | 45.7 | 206 | 52.5 |

### Example 4

0.01% and 0.02% hyaluronic acid added to cold and hot milk with 1% corn starch, results are shown in Table 4.

TABLE 4

| | Cold milk | | Hot milk | |
|---|---|---|---|---|
| Hyaluronic | Gel | Shear | Gel | Shear |
| acid (%) | stiffness (Pa) | stress (Pa) | stiffness (Pa) | stress (Pa) |
| 0 | 127 | 31.4 | 150 | 33.8 |
| 0.01 | 151 | 37.1 | 173 | 40.9 |
| 0.02 | 199 | 39.7 | 174 | 42.3 |

### Example 5

0.01% and 0.02% hyaluronic acid added to cold and hot milk with 1% waxy maize starch, results are shown in Table 5.

TABLE 5

| | Cold milk | | Hot milk | |
|---|---|---|---|---|
| Hyaluronic | Gel | Shear | Gel | Shear |
| acid (%) | stiffness (Pa) | stress (Pa) | stiffness (Pa) | stress (Pa) |
| 0 | 175 | 21.5 | 132 | 30.6 |
| 0.01 | 248 | 29.2 | 156 | 31.0 |
| 0.02 | 514 | 46.2 | 167 | 31.4 |

### Example 6

Different combinations of hyaluronic acid and Dynatex 3201B texturizer were added to cold milk and shear stress (Pa) was measured. Results are shown in Table 6.

TABLE 6
Shear stress (Pa) obtained in milk with addition
of Hyaluronic acid and Dynatex 3201B.

| | |
|---|---|
| Hyaluronic | Starch (%) |

| acid (%) | 0.0 | 0.5 | 1.0 | 2.0 |
|---|---|---|---|---|
| 0 | 25.1 | 30.3 | 36.1 | 40.4 |
| 0.01 | 27.7 | 31.2 | 42.0 | 50.9 |
| 0.02 | 28.5 | 30.4 | 44.4 | 76.4 |

1. A dairy product comprising hyaluronic acid and a second texturizing agent and one or more milk components and/or milk fractions.

2. The dairy product of claim 1, which is a fermented dairy product.

3. The dairy product of claim 1, which is a cheese.

4. The dairy product of claim 3, which is a fresh cheese.

5. The dairy product of claim 1, which is an ice cream.

6. The dairy product of claim 2, which is a yoghurt.

7. The dairy product of claim 1, wherein hyaluronic acid is produced by a microorganism.

8. The dairy product of claim 1, wherein the second texturizing agent is a carbohydrate.

9. The dairy product according to claim 8 wherein the second texturizing agent is selected among starch, modified starch, pectin, carageenan, locust bean gum, an alginate, agar agar, xanthan gum, guar gum, microcrystalline cellulose, chitin, chitosan, and/or konjac.

10. A method for producing a dairy product comprising
(a) mixing hyaluronic acid and a second texturizing agent with milk and/or one or more milk components and/or one or more milk fractions; and
(b) producing a dairy product from the mixture resulting from step (a).
